(19) United States
(12) Patent Application Publication
(10) Pub. No.: US 2018/0314986 A1
(43) Pub. Date: Nov. 1, 2018

(54) AUTOMATICALLY CALCULATING PROPOSED CONTENT DISPLAYS WITH FORECASTED RESULTS

(71) Applicant: OpenTable, Inc., San Francisco, CA (US)

(72) Inventors: COREY LAYNE REESE, Portola Valley, CA (US); JOSEPH ESSAS, Los Angeles, CA (US); NATHANIEL ELIJAH CHAIT, Berkeley, CA (US); MILES SKORPEN, San Francisco, CA (US); CLARENCE YUNG, Portland, OR (US)

(21) Appl. No.: 15/583,169

(22) Filed: May 1, 2017

(51) Int. Cl. G06Q 10/02; G06N 5/04; G06Q 30/02; G06F 17/30

(52) U.S. Cl. CPC G06Q 10/02; G06N 5/04; G06Q 50/12; G06F 17/30554; G06F 17/30864; G06Q 30/0267

(57) ABSTRACT

In an embodiment, a reservation server runs a reservation service that allows users of diner clients to reserve reservations with one or more restaurants. In addition, the reservation server runs a self-serve promotion service that restaurant clients to request automatic or semi-automatic generation of content displays for promotions. In some cases, the reservation server uses statistics to predict future periods of time when covers for a restaurant will be below average. The reservation server then automatically generates a promotion that is likely to increase covers during the previously predicted future periods of time. In response to the promotion being selected by a user, the reservation server generates a content display that is subsequently published to the reservation service. As a result, the content display is presented to users of the diner clients when searching for criteria satisfied by the restaurant.

### FIELD OF THE DISCLOSURE

The present disclosure relates to computer-implemented techniques for automatically calculating proposed content displays with forecasted results. The disclosure relates more specifically to processes, computer programs and computer systems that are programmed to create and transmit content displays having a specified type and duration based upon input parameters relating to prior performance of an operating unit.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Commercial operating units such as restaurants continually seek new ways via technology to increase demand for their products or services, resulting in increased production and income. A key way to generate demand is to transmit, using computer devices and networks, messages that identify or promote the operating unit and/or provide offers relating to the unit.

In the past, determining when to transmit such messages, and what parameters the messages should address, has been performed manually on an ad-hoc basis. The result is excessive use of network bandwidth, memory or storage for preparing and transmitting messages that are unlikely to affect demand. There is an acute need for an improved technological process to calculate when to generate and transmit a message, and what parameters the message should identify or contain.

### SUMMARY OF THE INVENTION

The appended claims may serve as a summary of the invention.

### BRIEF DESCRIPTION OF THE DRAWINGS

In the drawings:

FIG. 1 illustrates an example operating environment upon which an embodiment may be implemented.

FIG. 2 illustrates an example logical layout for a reservation server according to an embodiment.

FIG. 3 illustrates an example logical layout for a self-serve promotion module according to an embodiment.

FIG. 4 illustrates an example process flow for generating and publishing content displays in block diagram form according to an embodiment.

FIG. 5 illustrates an example cover prediction interface according to an embodiment.

FIG. 6 illustrates an example promotion generation interface according to an embodiment.

FIG. 7 illustrates an example content display preview interface according to an embodiment.

FIG. 8 illustrates a promotion results interface according to an embodiment.

FIG. 9 illustrates an alternative promotion results interface according to an embodiment.

FIG. 10 illustrates an example computer system for performing various machine-implemented steps described herein.

FIG. 11 illustrates another example mobile computer screen display that is programmed to display currently booked covers for a particular restaurant.

FIG. 12 illustrates another example of a promotion generation interface.

FIG. 13 illustrates an example screen display of a mobile computing device showing all or part of three (3) different suggested promotions.

FIG. 14 illustrates an example screen display of a mobile computing device showing a detailed view of the Bonus Points promotion of FIG. 13.

FIG. 15 illustrates the same example screen display of FIG. 14 except that the targeting panel has been expanded by tapping or other user input.

FIG. 16 illustrates the screen display of FIG. 13 after a promotion has been added to a campaign.

FIG. 17 illustrates an example mobile computing screen display that provides a weekly report for a “More Diners” campaign.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:
1.0 General Overview
2.0 Example Operating Environment
3.0 Reservation Server Overview
   3.1 Communications Module
   3.2 Reservation Module
   3.3 Self-Serve Promotion Module
4.0 Example Process Flow
5.0 Example User Interfaces
   5.1 Cover Prediction User Interface
   5.2 Promotion Generation User Interface
   5.3 Content Display Preview User Interface
   5.4 Promotion Results User Interface
   5.5 Alternative Promotion Results User Interface
6.0 Hardware Overview

### 1.0 General Overview

Systems, methods, and stored instructions are provided herein for automatically calculating proposed content displays with forecasted results. In one embodiment, a predictive process can determine a particular operating unit to present to a client computer device that is browsing booking data associated with a reservation-based service provider, such as a restaurant; the process is programmed to use the previous history of interactions of a consumer of a promotion or offer, including but not limited search history, cuisine preferences, price affinity, and location preferences to determine which operating unit to feature to the consumer. A programmed predictive model evaluates all operating units with eligible promotions or offers and identifies and presents the most relevant one to the consumer to maximize the likelihood that the consumer selects the promoted operating unit.

In an embodiment, a reservation server runs a service that allows users of diner clients to browse deals and promotions for setting up a reservation with one or more of a plurality of listed restaurants. For example, the reservation server may execute a web service that communicates with a diner client through a browser and use the browser to display one or more interfaces through which to obtain reservations with various restaurants. When a diner client sends a request to the reservation server to reserve a restaurant for a specific time period, the reservation server updates a reservation database to save the reservation. In addition, the reservation server sends one or more messages to restaurant clients which inform the restaurant staff as to the time, date, number of diners, and the party that made the reservation. For example, a message may be sent in the form of an email, automatic phone call, text, message sent to an application executing on the restaurant device, and so forth.

In an embodiment, the reservation server also runs a self-serve promotion service that guides restaurants through developing effective promotions and content displays to reach potential customers. In some embodiments, the self-serve advertising service analyzes stored data representing past bookings or reservations that diner clients have made, and actual table seatings at restaurants who seated and/or served diners associated with the diner clients, to identify historic trends to determine periods of time when the number of diners or number of served meals (referred to as covers) a restaurant is likely to experience are lower than normal. For example, the historic trends may be a result of analyzing the behavior of diners who use the reservation service provided by the reservation server.

In an embodiment, the reservation server then causes the restaurant client to display a widget prompting the owner or a staff member of the restaurant to set up a promotion campaign. Upon selecting the widget, the restaurant client displays an interface that allows for the selection of options related to the budget available for promotions. For example, the interface may allow a user to select the price per cover to be paid by the restaurant for the promotion and the maximum amount to be spent each day. Price values may be input or selected by entering numeric values or selecting prices from a list.

Upon receiving the selections from the restaurant client, the reservation server estimates an increase in number of covers and/or revenue that the restaurant is likely to receive as a result of the promotion campaign. Each such estimate may be based upon a comparative analysis of the restaurant with other similarly situated restaurants that have previously undertaken similar promotional campaigns or have stored attribute values that indicate similarity to the current restaurant. For example, if a first restaurant is an Italian restaurant in a central city location of a particular city, and the reservation database indicates that the first restaurant has seated 50 persons for dinner per night in the month of August, then data in the reservation database may indicate that a second Italian restaurant also in the same central city location has seated 75 persons for dinner per night in the month of September so that the estimated increase in covers for a September campaign is 25.

The resulting estimates are then communicated to the restaurant client for display. If the user finds the estimates acceptable, the interface provides another widget which can be selected to preview a content display representing the promotion. In addition to the preview, in some embodiments, the interface also includes additional widgets that allow the content display to be modified, such as changing the text, picture, alignment, size, and other features of the content display. Furthermore, in an embodiment, the interface is programmed to personalize content display based on stored data about the consumer of the promotion or offer. For example, some consumers may prefer content related to specific dishes, awards or other unique aspects of the operating unit.

In one embodiment, the system is programmed to generate and transmit notifications to alert the restaurant client computer that a diner has made a reservation, or has been seated at the restaurant. This notification may include additional information about the diner, including biographical details and dining preferences. Using the additional information, restaurant computers and staff acquire a basis to offer particular menus, dishes or beverages to a particular consumer. An example notification message is: “An International Traveler diner was just seated at Café Alpha using your Bonus Points campaign”.

In some embodiments, upon confirming that the content display is acceptable, the restaurant client displays statistics and diagrams that displays the details of the promotion campaign, the estimated increase in covers and revenue, and information indicating the current performance of the promotion. For example, the reservation server may continuously or periodically update the current performance information displayed by the restaurant client to show how many diners have made reservations through the promotion, including classifications of diners (e.g. new, regular, out-of-towners, etc.) and the manner in which the diner found the promotion (e.g. through a mobile app supported by the reservation server, through a website supported by the reservation server, through a website or app associated with the restaurant, and so forth). In some embodiments, the reservation server also provides information to the restaurant client representing the current reservations made with the restaurant. For example, the information may cause the restaurant client to display a map of the restaurant with the reserved tables for different periods of time marked with information such as the party who made the reservation, number of diners in the party, time period for which the party will need the reserved tables, and so forth.

During the time period specified for the campaign, various diner clients book tables via the reservation server and then appear at the restaurant for service. The reservation server continuously receives data signals from the restaurant client indicating which parties were seated in the restaurant and when, in association with data specifying which reservation or booking correlates to the party that was seated. For example, when a diner client has booked a table electronically through the reservation server, on the day of the reservation and near the time of the reservation, a graphical user interface generated at the restaurant client and visible in the restaurant lists bookings; when a party who made the booking arrives, the host at the restaurant may select the booking from the list and select a SEATED button, or the equivalent, to generate a signal indicating that the party for that reservation actually was seated and will be served. Therefore, the reservation database accumulates records of which reservations were fulfilled and the number of bookings or covers that the restaurant actually seated and served.

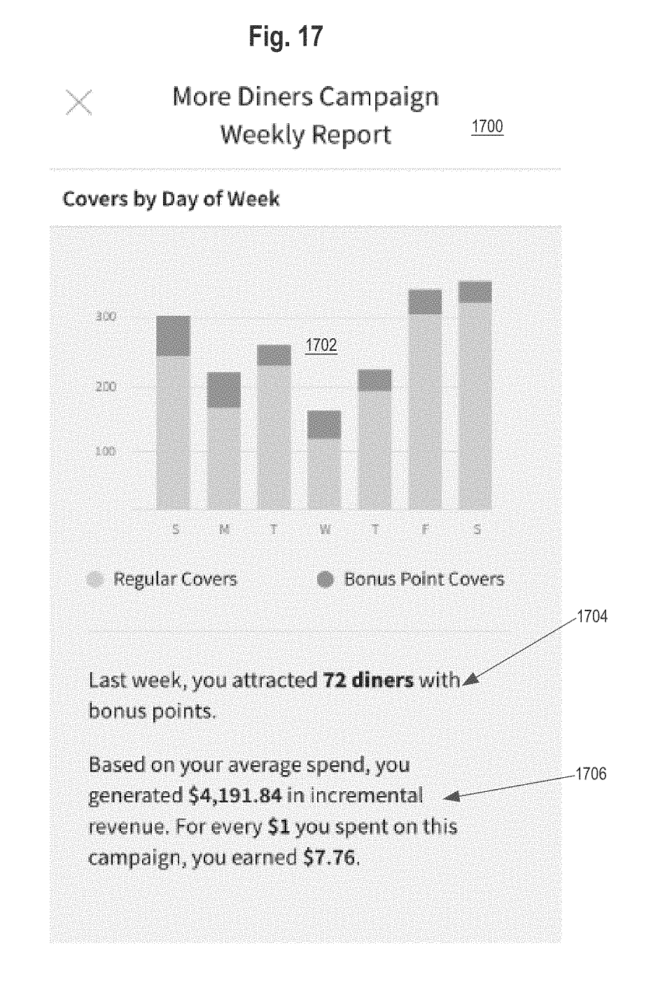

In some embodiments, after the time period for the promotion has ended, the reservation server provides a report to the restaurant client that states the efficiency of the campaign, such as how many covers were actually obtained through the promotion, the total revenue the restaurant earned from the promotion, how much money was paid to the owner of the reservation service for the promotion, and so forth. In various embodiments, reporting may occur using a management interface of the restaurant client, which receives data from the reservation server, or the reservation server may transmit e-mail messages to specified addresses associated with the restaurant and include reporting data in the messages. FIG. 17 illustrates an example mobile computing screen display that provides a weekly report for a “More Diners” campaign. In an embodiment, the screen display 1700 of FIG. 17 comprises a bar chart 1702 that states the number of regular covers and bonus point covers that were booked per day for the preceding week. Bonus point covers are those that resulted from the campaign and therefore the bar chart 1702 provides a way to efficiently and rapidly visualize results of the campaign. In an embodiment, the screen display 1700 of FIG. 17 further comprises a total diner message 1704 that specifies or reports a total number of diners that were attracted using the campaign for the preceding week, and a spend increase message 1706 that specifies or reports a total incremental revenue value that occurred as a result of the campaign for the preceding week; the spend increase message may also report the margin earned on the cost of the campaign based on the incremental revenue that was received. Each of the bar chart 1702, total diner message 1704 and spend increase message 1706 represents computer output based upon programmed algorithms that operate as described in previous sections to compile the data shown in the messages; that is, the chart and messages represent different computer functional operation.

In some embodiments, the reservation server learns which promotions are effective in which situations based on how effective promotions were in the past. For example, the efficiency of a promotion may be predicted based on how effective various promotions were at increasing covers at similar restaurants. In some embodiments, a feedback loop is utilized to continuously refine predictions, such as collecting statistics related to efficiency at the end of the campaign and adding those statistics to a database which is then used to drive future predictions made by the reservation server.

In some embodiments, the self-serve promotion service provided by the reservation server requires only information regarding the budget of the restaurant and then uses a generic promotion tool to attract potential diners. For example, the reservation server may put the restaurants having a promotion at the top of search results requested by potential diners and offer “points” for diners to make a reservation during the periods of estimated low covers. The points may later be spent to obtain free meals or discounts at restaurants registered with the reservation service. In some embodiments, the points also may be used to book reservations for seats or tables in an exclusive inventory associated with other restaurants where there are no tables that are publicly available or otherwise available. With this approach, certain consumers achieve a premium or VIP status and are able to obtain tables that those without such a status are unable to book.

Alternatively, the promotion may provide coupons to users which can then be exchanged for discounted or free food and drinks at participating restaurants. However, in other embodiments, the self-serve promotion service allows the restaurants to customize their own promotion. For example, the reservation server may cause the restaurant client to display interfaces allowing for restaurants to specify the type of promotion (e.g. coupons, points, advertisements, and so forth), the type of customer to direct the promotions towards (e.g. regulars, new customers, travelers, locals, high spenders, geographical region, etc.), time period for which to run the promotion, and so forth.

### 2.0 Example Operating Environment

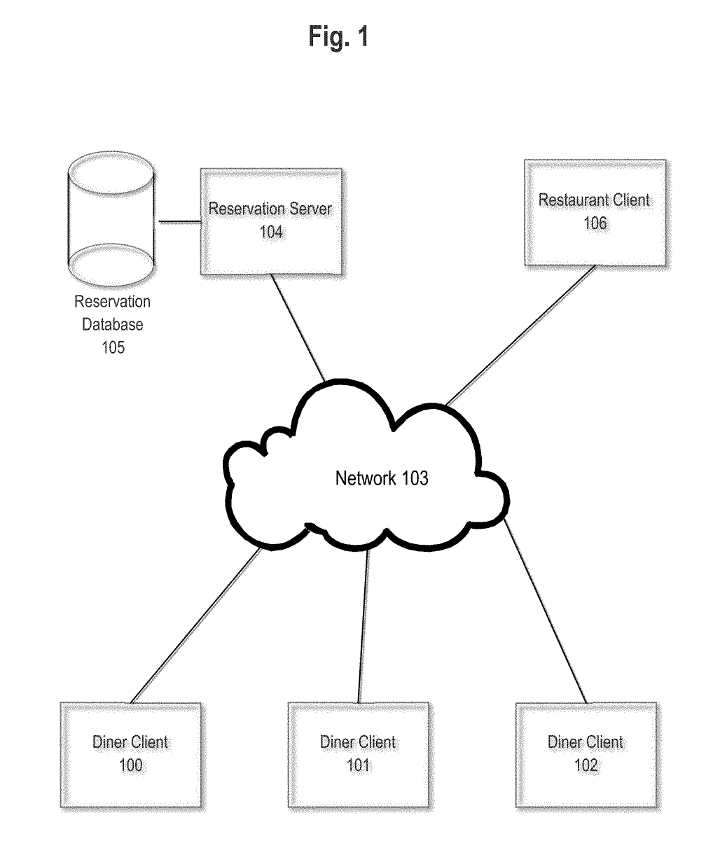

FIG. 1 illustrates an example operating environment upon which an embodiment may be implemented. In an embodiment, the operating environment includes diner client 100, diner client 101, diner client 102 (collectively the “diner clients”), network 103, reservation server 104, reservation database 105, and restaurant client 106.

In an embodiment, the diner clients represent computing devices, such as smartphones, tablets, laptops, desktops, and so forth. The computing devices represented by the diner clients may execute applications used to communicate with the reservation server 104 and display a set of user interfaces that can be manipulated by users to access a reservation service provided by the reservation server 104. For example, the application may be a web browser (such as Microsoft Edge, Firefox, Chrome, and so forth) in cases where the reservation server 104 provides services through a web interface. As another example, the application may represent a proprietary mobile or desktop application that may communicate with the reservation server 104 using any number of application-layer, presentation-layer, session-layer, transport-layer, and network-layer, protocols. In other embodiments, the diner clients represent the application themselves, rather than the device which executes the application.

In an embodiment, network 103 represents any combination of one or more local networks, wide area networks, or internetworks. Data exchanged over the networks may be transferred using any number of network layer protocols, such as Internet Protocol (IP), Multiprotocol Label Switching (MPLS), Asynchronous Transfer Mode (ATM), Frame Relay, and so forth. Furthermore, in embodiments where the networks represent a combination of multiple sub-networks, different network layer protocols may be used at each of the underlying sub-networks. In the example environment of FIG. 1, the network 103 communicatively couples the diner clients and the restaurant client 106 to the reservation server 104.

In an embodiment, the reservation server 104 represents one or more computing devices or resources, such a desktop computer, a server cluster, a cloud computing cluster, and so forth. The reservation server 104 provides both a reservation service to the diner clients and a self-serve promotion service to the restaurant client 106. Additional details regarding the configuration and functions of the reservation server 104 are described below in Section 3.0.

In an embodiment, the reservation database 105 represents one or more storage devices or services which are accessible to the reservation server 104, such as RAM, hard drive disks, RAID drives, cloud storage, database management systems, and so forth. The reservation database 105 stores information related to the restaurants available through the reservation service. For example, the restaurants may be associated in the reservation database 105 with information such as name, cuisine type, time and date availability, current reservations for various time periods, reviews submitted by diners, menus, price ranges, and so forth. In some embodiments, the reservation database 105 also stores historic trend information (e.g. covers received by restaurants over time, revenue generated by the restaurant over time, efficiency of various types of promotions previously used by the same or similar restaurant types, average changes in covers for the restaurants throughout a day, week, or other time period, and so forth) used to generate estimates and predictions for the self-serve promotion service provided to the restaurant client 106.

The information stored in the reservation database 105 may be stored in virtually any format, such as a flat file database, a relational database, an object-relational database, and so forth. In some embodiments, reservation database 105 may include both one or more storage devices and one or more database servers that provide access to the storage devices. For example, the reservation database 105 may be coupled to a database server that is configured to accept queries and updates in the form of database language, such as SQL, and execute those commands on the associated storage devices. In some embodiments, the functions of the database server may be implemented on the reservation server 104, rather than being a separate stand-alone database server.

In an embodiment, the restaurant client 106 represents one or more computing devices, such as smartphones, tablets, laptops, desktops, and so forth. The computing devices represented by the restaurant client 106, in some embodiments, may execute applications used to communicate with the reservation server 104 and display a set of user interfaces that can be manipulated by users of the restaurant client 106 to access a self-serve promotion service provided by the reservation server 104. For example, the application executed may be a web browser (such as Microsoft Edge, Firefox, Chrome, and so forth) in cases where the reservation server 104 provides services through a web interface. As another example, the application may represent a proprietary mobile or desktop application that may communicate with the reservation server 104 using any number of application-layer, presentation-layer, session-layer, transport-layer, and network-layer, protocols.

In an embodiment, through network 103, the reservation server 104 receives a signal from the restaurant client 106 when a diner has been seated at a restaurant that hosts the restaurant client, based upon a reservation or booking that a diner client 100, 101, 102 created by networked communication with the reservation server. Therefore, reservation server 104 can collect and store in reservation database 105 records of past table bookings and seatings in association with values identifying a particular restaurant. Reservation server 104, or other back-end computers that are coupled to reservation database 105, may be programmed with algorithms that generate and store trend data specifying days or times at which traffic is higher or lower.

Although FIG. 1 illustrates a specific number of each depicted element, the number chosen is used as an example and not as a limitation. Practical environments may contain hundred, thousands, hundreds of thousands, or more of each depicted element. Furthermore, other embodiments may divide out elements depicted in FIG. 1 into additional elements. For example, the reservation server 102 may be split into two separate servers, one which handles the processing of reservations for the diner clients and another which implements the self-serve promotion service for the restaurant client 106. Furthermore, the depicted elements and their associated functions may be combined, one or more new elements not depicted within FIG. 1 may be added, and/or one or more elements depicted in FIG. 1 may be removed in other embodiments.

### 3.0 Reservation Server Overview

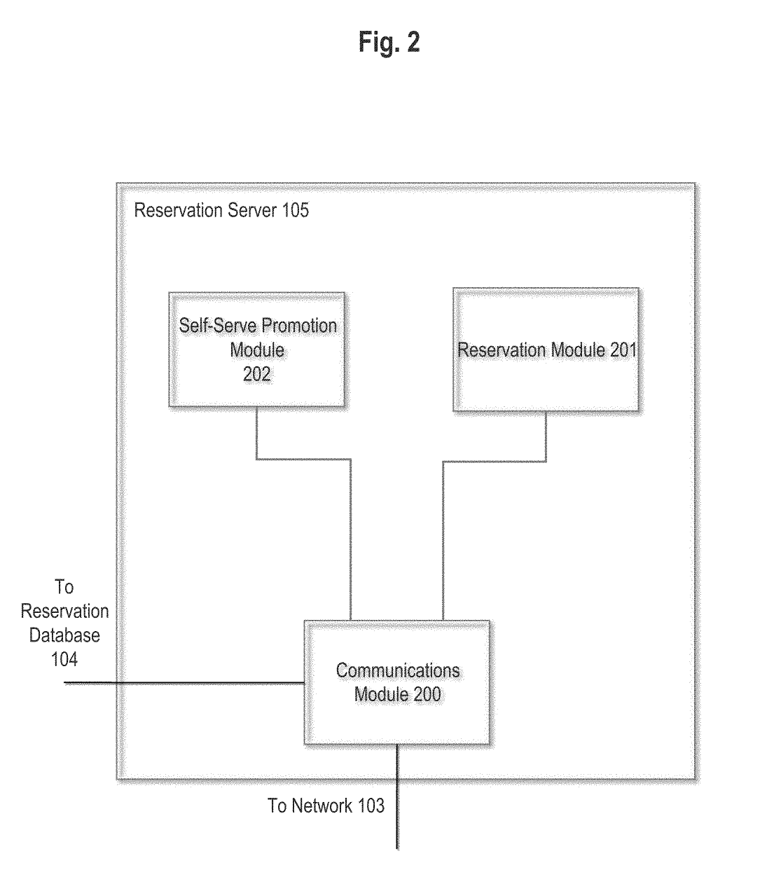

FIG. 2 illustrates an example configuration for the reservation server 104 according to an embodiment.

In FIG. 2, various elements are described in terms of modules. The term module may refer to sets of executable instructions or computer programs; when executed by one or more processors, these instructions or programs cause a computer to execute the tasks, functions or operations that are specified in this description in association with the module. In other embodiments, a module comprises hardware that is configured to perform the described tasks, or a combination of software and hardware that is configured to perform the described tasks. A module may comprise a discrete or identifiable set of executable program instructions that is stored in a region of digital electronic memory of a computer. Each of the flow diagrams set forth herein specifies an algorithm that may be used to implement one or more of the modules, or parts of one or more modules, using executable instructions or programs.

In addition, FIG. 2 illustrates a specific number of modules included within the reservation server 104. However, in other embodiments the modules may be combined into a smaller set of modules or divided into multiple sub-modules compared to the illustration of FIG. 2. Furthermore, embodiments may split the modules depicted in FIG. 2 between multiple servers, such as one server that implements the self-serve promotion module 202 and another that implements the reservation module 201.

In FIG. 2, the reservation server 104 includes a communications module 200, a reservation module 201, and a self-serve promotion module 202, each of which is described in separate sections that follow.

### 3.1 Communications Module

In an embodiment, communications module 200 represents a component of the reservation server 104 that processes communications between the reservation server 104 and the reservation database 105, diner clients, and restaurant client 106. In some embodiments, the communications module 200 may be configured to forward messages from the reservation database 105, diner clients, and/or restaurant client 106 to an appropriate module of the reservation server 104. For example, requests directed towards the reservation service may be forwarded to reservation module 201 and requests directed towards the self-serve promotion service may be forwarded to self-serve promotion module 202. In some embodiments, the communications module 200 relays information to the self-serve promotion module 202 and the reservation module 201 using one or more inter-process communications mechanisms, such as through an Application Programming Interface (API), a Remote Procedure Call (RPC), and so forth.

Although the communications module 200 is depicted as a single component, in other embodiments the communications module 200 may represent multiple sub-components, each of which handles a different layer of communications. For example, each sub-component may handle communications from a different layer of the seven layer OSI model. Thus, the communications module 200 may handle application layer messages, network layer packets, link layer frames and so forth. A “communication” is defined to be an umbrella term for the units of data and/or instructions sent and received for any communication layer. Furthermore, communications module 200 may implement multiple communication protocols that function at the same layer of the OSI model. For example, the communications module 200 may have one sub-module that handles web-based application-layer requests (such as HTTP messages) from the diner clients and/or restaurant client 106 and another sub-module that sends application-layer requests in a database query language (such as SQL) to reservation database 105.

### 3.2 Reservation Module

In an embodiment, the reservation module 201 represents a component that implements the reservation service of the reservation server 104 utilized by the diner clients. In some embodiments, the reservation service provided by the reservation module 201 allows users to search for restaurants in various geographical areas, browse reservation openings at the restaurants, and take advantage of promotions offered by the restaurants.

In an embodiment, the diner clients access the reservation service by “logging in” to an account associated with the reservation server 104. For example, the reservation database 105 may include records representing a plurality of users that identify information such as user name, password, dining history, favorite restaurants of the user, statistics regarding previous spending on restaurants, statistics regarding how frequently the user makes reservations or dines at various restaurants, statistics regarding the type of promotions the user previously selected, and so forth. Thus, a user may log in by supplying their user name and password to be granted access to their account. Once the user is logged in, the user is presented with an interface allows the user to search for restaurants by a number of factors, such as location, distance, price, type of cuisine, time and date when reservation will be made, size of party to accommodate, and so forth. For example, the reservation service may be provided as a web service, where the diner clients execute browsers that are configured to communicate with the restaurant server 104 via a communications protocol such as HTTP. However, in other embodiments, the reservation service may be provided by clients which are executing a mobile app or a proprietary application which may communicate with protocols other than web protocols.

Upon submitting the search, the user is presented with a list of restaurants to select from that can accommodate the reservation required by the user. From there, the user may select a restaurant with which to make the reservation. In some embodiments, the reservation server 104 also sends the reservation information to the restaurant client 106 associated with the restaurant selected by the user. For example, the reservation data may be sent through an email, an automatic phone call, sent and displayed to the restaurant client the next time the restaurant client 106 logs in to a service provided by the reservation server 104, and so forth.

In some embodiments, whenever one of the diner clients makes a reservation through the reservation service, the reservation module 201 collects statistics that are then stored in the reservation database 105. For example, the statistics may include how frequently a restaurant is booked through the reservation service, a breakdown of the types of customers which reserve seats at a given restaurant, the times when various restaurants are more or less popular, the average revenue of various restaurants or types of restaurants, how many customers previously used a promotion for various restaurants, the types of promotions that are popular with various types of customers, and so forth. In addition, in some embodiments, restaurants that participate in the reservation service may have a point of sale (POS) device that collects feedback from the sales at the restaurant, such as the types of food ordered, the amount spent for each meal, whether that customer reserved the seat through the restaurant service or by external means, and so forth. The statistics collected by the reservation module 201 are then later used by the self-serve promotion module 202 to identify times when turnout to a restaurant will be below average and automatically determine promotions that are likely to increase the number of covers during those times.

### 3.3 Self Serve Promotion Module

In an embodiment, the self-serve promotion module 202 represents a component that implements the self-serve promotion service of the reservation server 104 that is utilized by the restaurant client 106. In some embodiments, the self-serve promotion service is implemented as a web service where the self-serve promotion module 202 acts as a web server communicating with a web browser executing on the restaurant client 106. However, in other embodiments, the restaurant client 106 may represent a mobile device communicating with a mobile service provided by the self-serve promotion module 202 or may represent a proprietary client application executing on the restaurant client 106.

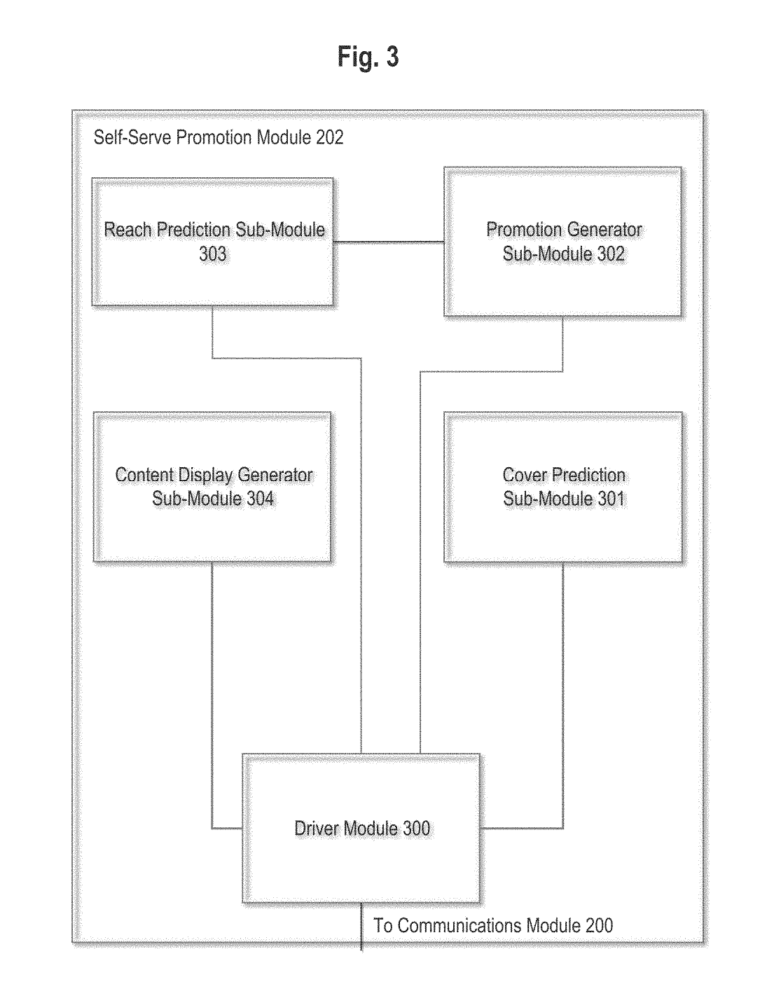

FIG. 3 illustrates an example logical design for the self-serve promotion module 202 according to an embodiment. In FIG. 3, the self-serve promotion module includes driver sub-module 300, cover prediction sub-module 301, promotion generator sub-module 302, reach prediction sub-module 303, and content display generator sub-module 304.

In an embodiment, driver sub-module 300 represents a component of the self-serve promotion module 202 that generates messages which when sent to the restaurant client 106 to cause the restaurant client 106 to display a particular interface or modify an existing interface. For the sake of brevity, the aforementioned generation of messages is referred to as “generating” an interface. However, in some embodiments, the aforementioned task of generating an interface may be shared among multiple sub-modules of the self-serve promotion module 202. For example, in cases where the self-serve promotion service is implemented as a web service, the driver sub-module 300 may generate HTTP messages which carry information that when interpreted by a browser of the restaurant client 106 causes the browser to produce a particular interface. In some embodiments, the driver sub-module 300 invokes the other sub-modules of the self-serve promotion module 202 to determine what to populate in various fields of the generated user interface.

For example, a user of the restaurant client 106 may “log in” to their account and be presented with an interface or series of interfaces that displays one or more of: a period of time where covers will be lower than normal (e.g. in a chart of graph displaying the prediction compared to a normal amount of covers for the restaurant), one or more promotions that may be selected, and/or the estimated increase in covers and/or revenue that the promotion would generate. In order to display the period of time where covers will be lower than normal the driver sub-module 300 invokes the cover prediction sub-module 301 to determine the number of estimated covers for each division of a set period of time (e.g. 3 day forecast, weekly forecast, etc.). In order to display the one or more promotions the driver sub-module 300 invokes the promotion generator sub-module 302 to generate one or more promotions to display. In order to display the estimated increase in covers and/or revenue, the driver sub-module 300 invokes the reach prediction sub-module 303. In response to a user selecting a promotion, the driver sub-module 300 invokes the content display generator sub-module 304 to generate a content display for the selected promotion. For example, the content display sub-module may generate one or more interfaces through which to upload or select an image and/or customize an image by adding text, graphics, cropping the image, and so forth. Additional examples of the interfaces that may be generated by the driver sub-module 300 are discussed below in Section 5.

As discussed below, the invoked modules each may require information such as the name or ID of the restaurant associated with the user, statistics regarding the effectiveness of promotions, demographics of the patrons of the restaurant, a period of time over which to run a promotion, and so forth. Depending on the embodiment, the inputs may be hardcoded into the driver sub-module 300, prompted for input by a user of the restaurant client 106, the results generated by other sub-modules, data retrieved from the reservation database 105, or a combination of the foregoing.

In an embodiment, cover prediction sub-module 301 represents a component of the self-serve promotion module 202 that predicts the number of covers a given restaurant will have during one or more periods of time into the future (e.g. days, weeks, months, etc.). In some embodiments, the cover prediction sub-module 301 receives as input one or more factors relating to a restaurant and produces an estimated number of covers that the restaurant should receive. For example, the factors may include the current date, the time period in which to predict the date (e.g. next three days, next week, next month, etc.), the granularity of the time periods (e.g. prediction each day, half day, hour, etc.), the name or identifier of the restaurant, and so forth. After receiving the one or more factors, the cover prediction sub-module 301 retrieves (via the communications module 200) statistics related to previous covers by the restaurant and similar restaurants from the reservation database 105. Similarity may be determined by location, type of cuisine, price, other measures of similarity, and/or weighted combinations.

The cover prediction sub-module 301 then uses the statistics described above to generate the number of predicted covers that the restaurant would likely receive at some point in the future. In an embodiment, the cover prediction sub-module 301 is programmed to use a stored conversion rate value for a particular restaurant, adjusted by rank position, multiplied by an estimated number of exposures in search results. For instance, if a restaurant that is normally or “organically” ranked number “#150” is boosted to the “#1” position 10,000 times over a one week period and has a 1% conversion rate, then the cover prediction sub-module 301 may output a prediction that 50-150 incremental covers would be generated by inorganically boosting the restaurant to the #1 position in search results.

The predicted number of covers for the one or more periods of time are then passed back to the driver sub-module 300 which may determine whether a sub-set of the one or more periods of time are associated with predicted covers that are below average for the restaurant.

In an embodiment, promotion generator sub-module 302 represents a component of the self-serve promotion module 202 that generates an optimal promotion for a given restaurant over a given time. For example, the promotion generator sub-module 302 may test a set of promotions using the reach prediction sub-module 303 and select the promotion that best increases covers and/or revenue for the restaurant over that period of time. The promotion may then be returned to the driver sub-module 300 for transmission to the restaurant client 106 for display. However, in other embodiments the promotion generator sub-module 302 may return the top N promotions rather than the single top-rated promotion.

Other embodiments may use a static set of promotions rather than attempting to determine an optimal promotion. For example, the user interface may include a widget, such as a set of buttons or a dial that allows a user to select between different promotions. When a promotion is selected the reach prediction sub-module 303 is invoked by the driver sub-module 300 to update the user interface to display the resulting gains in covers and/or revenue that would be obtained if the promotion were used. Still other embodiments may take a hybrid approach, and may automatically suggest a promotion or top N set of promotions and then display the static set of promotions if the suggestion is declined.

In an embodiment, reach prediction sub-module 303 represents a component of the self-serve promotion module 202 that determines how many covers and/or how much revenue a given promotion is likely to obtain for a given restaurant. In some embodiments, the reach prediction sub-module 303 receives as input one or more factors relating to a given restaurant and given a promotion and produces an estimated number of increased covers and/or amount of revenue that the restaurant is likely to receive should that promotion be chosen. For example, the factors may include the current date, the time period for which the promotion will run, the name or identifier of the restaurant, the type of promotion, level of the promotion (e.g. each type of promotion may have additional levels depending on price), and so forth. After receiving the one or more factors, the reach prediction sub-module 303 retrieves (via the communications module 200) statistics related to how effective previously run promotions were at increasing covers/revenue covers. The reach prediction sub-module 303 then uses the statistics to estimate the number of covers and/or revenue the restaurant will receive using the given promotion.

In an embodiment, content display generator sub-module 304 represents a component of the self-serve promotion module 202 that generates a content display for a given promotion. In an embodiment, the content display may include one or more advertisements that are generated automatically, using a combination of images, metadata, and text to create a unique package of merchandising to entice a diner or diner device to click on the promoted restaurant. For instance, if stored consumer preference data indicates that a diner viewing the promoted restaurant has an affinity for steak tartare, then the content display generator sub-module 304 may show a snippet of a review that mentions “exceptional steak tartare,” paired with an image submitted by a user of the steak tartare at that restaurant, which has been labeled as an image of steak tartare by the user who uploaded it.

In other circumstances, the content display generator sub-module 304 may be programmed to allow a restaurant to choose its own image and message that is shown to all users viewing a promoted restaurant. In one embodiment, each restaurant uploads or has previously uploaded one or more graphical images for use in messages from the restaurant client 106 to the reservation server 104 for use in promotional messages. In some embodiments, the content display generator sub-module 304 selects a random image from a static library set of images, imprints text specifying the promotion onto the selected image, and passes the image up to the driver sub-module 300. However, in other embodiments, the content display generator sub-module 304 generates one or more customization interfaces for the restaurant client 106 that allow a user to customize the content display. For example, the customization interfaces may include interfaces for uploading an image, cropping an image, adding text to image, modifying text on image, and so forth. Still other embodiments may use a hybrid technique, such as by generating the image automatically ahead of time and then providing tools which enable a user to customize the image afterward.

In some embodiments, when a message is received from a user that confirms the content display, the driver sub-module 300 publishes the content display. For example, the driver sub-module 300 may flag the restaurant in the reservation database 105 as currently running a promotion. The flag, when interpreted by the reservation module 201, causes the reservation module 201 to prominently display the restaurant in any listing of restaurants, such as may occur when one of the diner clients submits a search that is satisfied by the restaurant running the promotion. The display may be bolded, put at the top or near the top of the list, may be advertised in a pop-up on the user interface displayed by the diner clients, and so forth.

### 4.0 Example Computer Process Flow

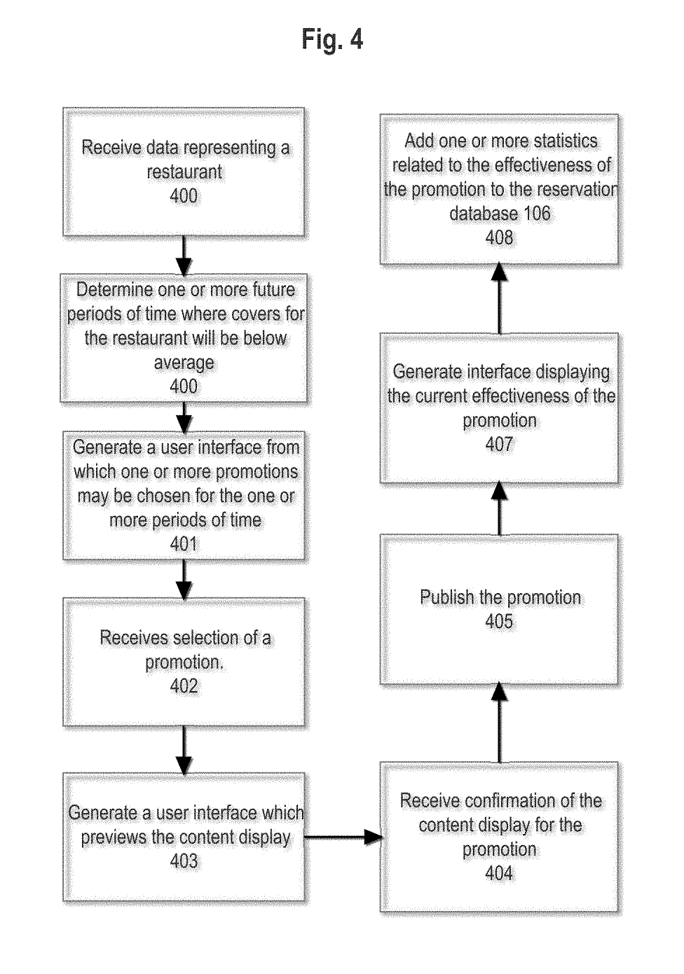

FIG. 4 illustrates an example process flow for a self-serve promotion service in block diagram form according to an embodiment. In order to present a clear example, the following explanation assumes FIG. 4 is performed by the self-serve promotion module 202 and the sub-modules included within self-serve promotion module 202.

In FIG. 4, at block 400 the self-serve promotion module 202 receives data representing a restaurant. For example, the information may be sent to the self-serve promotion module 202 by the communications module 200 in response to a user logging in to the self-serve promotion service. The communications module 200 may perform a lookup into accounts represented within the reservation database 105, find a restaurant name or ID associated with the user, and invoke the self-serve promotion module 202 with the restaurant name or ID. In some embodiments, the data representing the restaurant is received by the driver sub-module 300 of the self-serve promotion module 202.

At block 401, the self-serve promotion module 202 determines one or more periods of time in the future where covers for the restaurant are expected to be below average. In an embodiment, the self-serve promotion module 202 determines the one or more periods of time by invoking the cover prediction sub-module 301. For example, the cover prediction sub-module 301 may use statistical values that are stored in the reservation database 105 or calculated at the time of executing block 401, and related to covers at the same or similar restaurant for a given future time or date during which a campaign will occur. In some cases, comparisons could be made to cyclical periods of time, such as comparing all Mondays at 1:00 PM for the same or similar restaurants, comparing all breakfast service in a specified time period, and so forth. Database 105 may store attribute values that provide an analytical basis for such comparisons, such as cuisine, address, neighborhood, price point or others. At block 402, the self-serve promotion module 202 generates a user interface from which one or more promotions may be chosen for the one or more periods of time determined at block 401. In some embodiments, the self-serve promotion module 202 invokes the promotion generator sub-module 302 to generate the promotions to display in the user interface. For example, the promotion generator sub-module 302 may cause the display of a static set of promotions or may determine a best or top N promotions for the periods of time to display. For embodiments which rely upon the estimated increase in covers and/or revenue for a given promotion, the promotion generator sub-module 302 invokes the reach prediction sub-module 303 to generate those estimates. Those estimates may be used to select the promotion or may be passed back up to the driver sub-module 300 via the promotion generator sub-module 302 for display alongside the promotions themselves. For example, the user interface may display each promotion in association with the estimated covers or revenue gained by selecting that promotion.

In some embodiments, the user interface includes one or more widgets, such as dials, buttons, sliding bars, and so forth that allow the promotion to be customized, such as by inputting a price acceptable to pay for the promotion, types of diners to focus on (e.g. regulars, new customers, travelers, etc.), adjustments to one or more features or settings of the promotion, and so forth. In some embodiments, when a promotion is customized, the reach prediction sub-module 303 is invoked to update the display with the number of covers or amount of revenue that is predicted to be achieved by the promotion after the modification submitted by the restaurant client 106. The display may also update the price paid per cover for the promotion as the dials, buttons, sliding bars and so forth are interacted with to determine the characteristics of the campaign. For instance, if a consumer computer selects “Travelers” from a list of targeting criteria, then the projected price per cover for the campaign may increase from $3.00 to $7.50.

In some embodiments, the user interface generated at block 402 describes or illustrates the one or more periods of time determined at block 401, such as by displaying a graph with one axis being time and the other axis being predicted covers vs. average covers. However, in other embodiments, the interface may be displayed between block 401 and block 402 that illustrates the predicted number of covers and invites the user to explore promotion options via selection of one or more widgets, which then cause the promotion generator sub-module 302 to be invoked to display one or more promotion options that can be pursued.

At block 403, the self-serve promotion module 202 receives selection of a promotion. In an embodiment, the user interface displayed at block 402 includes one or more widgets, such as checkmark boxes, buttons, slide bars, and so forth that allow one of the displayed promotions to be chosen. Thus, in such embodiments, the self-serve promotion module 202 receives selection of the promotion in response to a user selecting the promotion via the one or more widgets. The selection of the one or more widgets then causes the restaurant client 106 to send one or more communications to the self-serve promotion module 202, which then determines the selection based on the promotion identified in the one or more communications.

At block 404, the self-serve promotion module 202 generates a user interface which previews the content display. Generating a user interface includes both the case where a new interface is generated or when instructions are generated which cause an already displayed user interface to be modified. In an embodiment, the driver sub-module 300 invokes the content display generator sub-module 304 to automatically or semi-automatically generate a content display for the promotion selected at block 403. For example, the content display generator sub-module 304 may randomly select an image from a library of background images and imprint text identifying the promotion, the restaurant, a slogan, or other message for potential diners to view. The text imprinted on the background image may be chosen from a set of text associated with the selected promotion or be text associated with the restaurant, such as the name of the restaurant. In some embodiments, the content display generator sub-module 304 automatically generates a content display, but then includes in the user interface one or more widgets which allow the content display to be edited before submission. For example, the user may be prompted to edit the text imprinted on the image, change the background image, upload a background image, crop the background image, and so forth. In some embodiments, the content display generator sub-module 304 does not automatically generate an image and instead displays the editing widgets described above to allow the user to create their own content display.

At block 405, the self-serve promotion module 202 receives confirmation of the content display for the promotion. In an embodiment, the user interface generated at block 404 includes one or more widgets that allow the content display to be confirmed by the user. For example, the content display may include a button marked “CONFIRM” that when selected causes the restaurant client 106 to send instructions to the driver sub-module 300 which specify that the current content display is confirmed.

In some embodiments, the user interface which previews the content display is optional. For example, the driver sub-module 300 may display a user interface which queries whether the user would like a preview of the content display. If the user opts to preview the content display, block 404 and block 405 are performed, otherwise if the user chooses not to preview the content display, block 404 and block 405 may be skipped. Instead, the driver sub-module 300 invokes the content display generator sub-module 304 to automatically generate a content display, which is treated as the content display confirmed by the user for the promotion.

At block 406, the self-serve promotion module 202 publishes the promotion. In an embodiment, the driver sub-module 300 of the self-serve promotion module 202 publishes the promotion. In some embodiments, the promotion is published by modifying the data stored in the reservation database 105 to indicate that the restaurant associated with the user of the restaurant client 106 is running a promotion, such as setting a flag associated with the name or ID of the restaurant. In some embodiments, the reservation module 201 is configured to rank restaurants with promotions higher than restaurants that are not running the promotion or may have a special section of a user interface reserved for displaying restaurants with promotions when one of the diner clients searches through restaurants using the reservation service. In addition, the content display confirmed at block 404 and/or the details of the promotion may be stored in the reservation database 105 in association with the restaurant. Thus, when one of the diner clients performs a search for restaurants using the reservation service provided by the reservation module 201, restaurants which match the query and which have promotions may be displayed using the content display confirmed at block 404 by itself or in association with one or more details of the promotion (e.g. how long the promotion will run, points or savings earned during the promotion, any restrictions on the promotion, and so forth).

At block 407, the self-serve promotion module 202 generates an interface displaying the current effectiveness of the promotion. In some embodiments block 407 represents an interface that may be accessed by logging into the account associated with the user of the restaurant client 106 at any time after the promotion is published. For example, right after the promotion is published there may be insufficient time to discern whether or not the promotion has been effective. Thus, users of the restaurant client 106 may log in periodically to keep track of a current promotion or view the effectiveness of previously run promotions. In some embodiments, when a user logs into their account the restaurant client 106 presents a home page displaying the effectiveness of the currently running and/or previously executed promotions. Alternatively the home page may have a link or widget that can be selected to cause the effectiveness of current or previous promotions to be displayed. The interface may include the current covers or revenue generated by the promotion thus far, the expected covers and/or revenue generated by the promotion, details regarding targeted diner types (e.g. regulars, visitors, big spenders, etc.), details regarding actual diner breakdowns of covers generated by the promotion, and so forth.

At block 408, the self-serve promotion module 202 adds one or more statistics related to the effectiveness of the promotion to the reservation database 105. In an embodiment, when a promotion has completed, the driver sub-module 300 collects one or more statistics related to the performance of the promotion. The aforementioned statistics are then stored in the reservation database 105 and are then used by the reach prediction sub-module to refine future predictions.

In an embodiment, the statistics that are collected include, but are not limited to: 1) the rank position at which the promotion was shown in search results; 2) the restaurant identifier of the promoted restaurant; 3) the user id of the user viewing the promoted restaurant; 4) whether or not the user clicked on the promoted restaurant; 5) whether or not the user reserved at the restaurant; 6) the amount of time the user spent browsing the page of the promoted restaurant; 7) whether the user viewed the promoted restaurant (e.g. did the user scroll low enough in search results such that it would be presented). In an embodiment, a feedback loop is programmed in the system and used to optimize for the CTR and Conversion Rate of promoted restaurants, using machine learning techniques to predict the expected value between a promoted restaurant in a specific rank position and a diner using the formula: EV=eCTR*eConversion*Commision Rate.

### 5.0 Example User Interfaces

Below are a variety of example interfaces which may be displayed by the restaurant client 106 with or without prompting by the self-serve promotion module 202. However, the techniques described herein are not limited to any particular interface layout and in other embodiments may differ drastically from the example interfaces presented below.

### 5.1 Cover Prediction User Interface

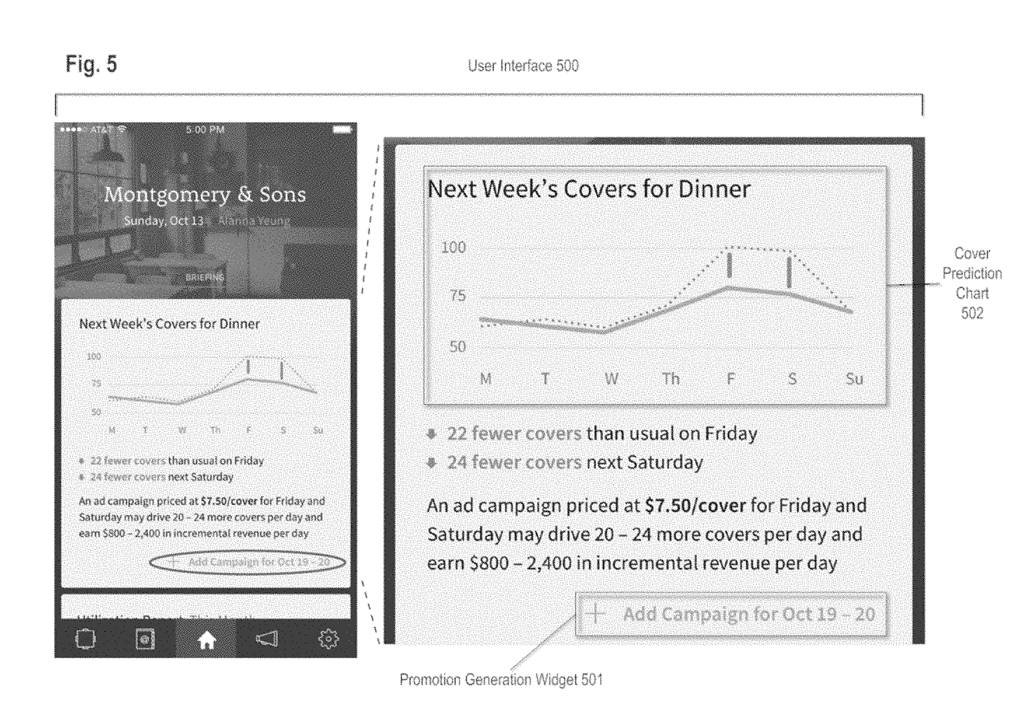

FIG. 5 illustrates an example cover prediction interface according to an embodiment. In FIG. 5 the user interface 500 displays information describing the predicted covers for each day over the next week including cover prediction chart 502, information describing a suggested promotion and the predicted effect on covers, and a promotion generation widget 501 that can be selected by the user to add the promotion.

In an embodiment, the cover prediction chart 502 displays a graphic that illustrates how many covers the restaurant is likely to receive over a future period of time, in this case a week. For example, the x-axis may represent various units of time (e.g. a day) and the y-axis represents the number of covers that the restaurant is predicted to obtain over those units of time. Although a line chart is used in the depicted example, other embodiments may use other types of charts or graphics, such as a bar chart. In some embodiments, in addition to the cover prediction chart 502 the user interface displays in the vicinity of the cover prediction chart additional information related to predicted covers, such as text that identifies the periods of time corresponding to less covers than average for those periods of time.

In some embodiments, the user interface 500 displays one or more promotions that may be selected to increase covers for periods of time which have been predicted to have lower turnout than usual. In FIG. 5, the user interface 500 includes text that identifies the type of promotion that may be used for the periods of lower predicted covers and an explanation of the number of increased covers and revenue that is likely to result from selecting the promotion. In addition, the aforementioned text may be displayed in the vicinity of a promotion generation widget 501 which allows a user to select one of the displayed promotions. In the case of FIG. 5, only one promotion is displayed. However, other embodiments may display multiple promotions for the user to choose between.

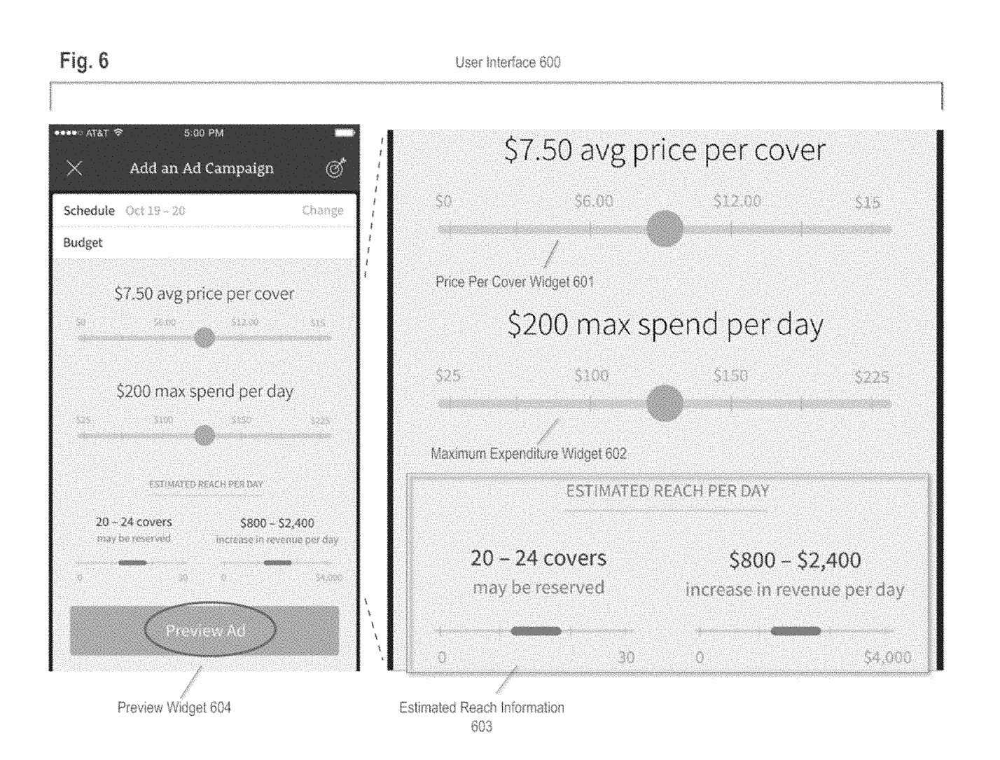

In some embodiments, the user interface 500 is depicted as a result of the self-serve promotion module 202 performing block 402. However, other embodiments may use a different process flow, such as displaying only the predicted covers for the week and providing a link that a user may select to see potential promotions that can be used to increase covers over various periods of time. In an embodiment, selection of the promotion generation widget 501 acts as a trigger that drives the driver sub-module 300 to display the interface depicted in FIG. 6.

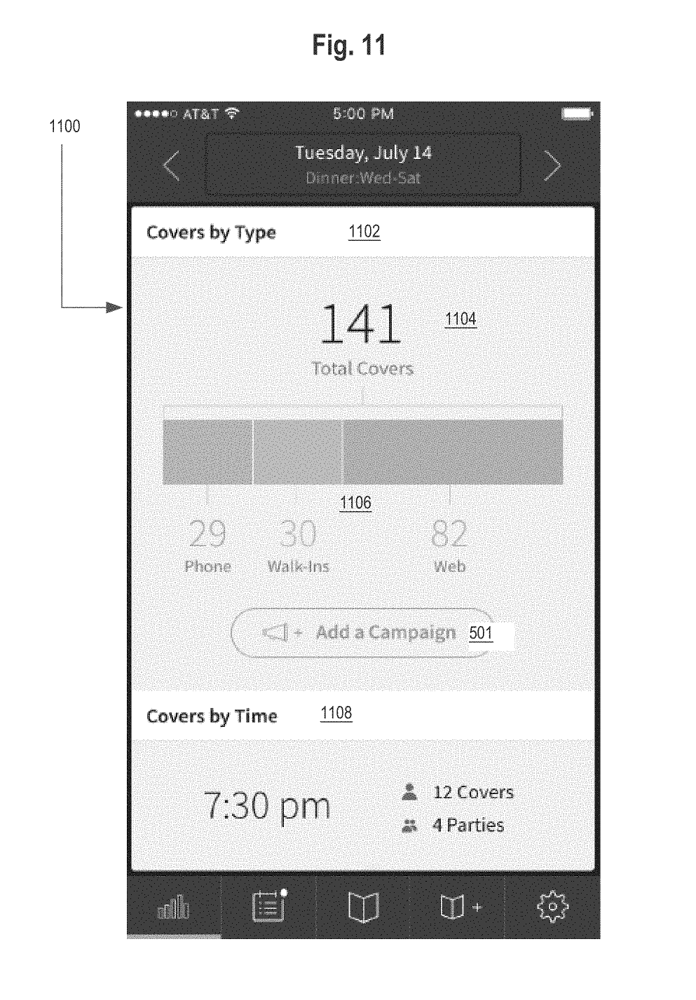

FIG. 11 illustrates another example mobile computer screen display that is programmed to display currently booked covers for a particular restaurant. In an embodiment, screen display 1100 comprises a type data panel 1102 and a time data panel 1108. The type data panel 1102 comprises a total indicator 1104 that displays the total number of covers currently booked for the restaurant for a particular day. A bar display 1106 may indicate the distribution of the total covers among a plurality of different modes of booking that were used to book the covers, such as phone, online or, and walk-ins. The time data panel 1108 may indicate the number of covers booked per time slot from among a plurality of time slots and may be organized as a scrollable widget to permit viewing other time slots by using a dragging, swiping or other touch screen movement gesture. In an embodiment, an “Add a Campaign” icon 501 operates as a promotion generation widget that can be selected by the user to add a promotion.

### 5.2 Promotion Generation User Interface

FIG. 6 illustrates an example promotion generation interface according to an embodiment. In FIG. 6, the user interface 600 displays a price per cover widget 601 and a maximum expenditure widget 602 which allow a user to set how much the user is willing to spend per cover obtained through a promotion and a maximum amount spent each period of time (e.g. each day) respectively. In addition, the user interface 600 provides estimated reach information 603 that provides an estimate for the number of covers and amount of revenue gained by pursuing the selected promotion. Finally, the user interface 600 includes a preview widget 604 that allows a user to preview a content display used to advertise the promotion.

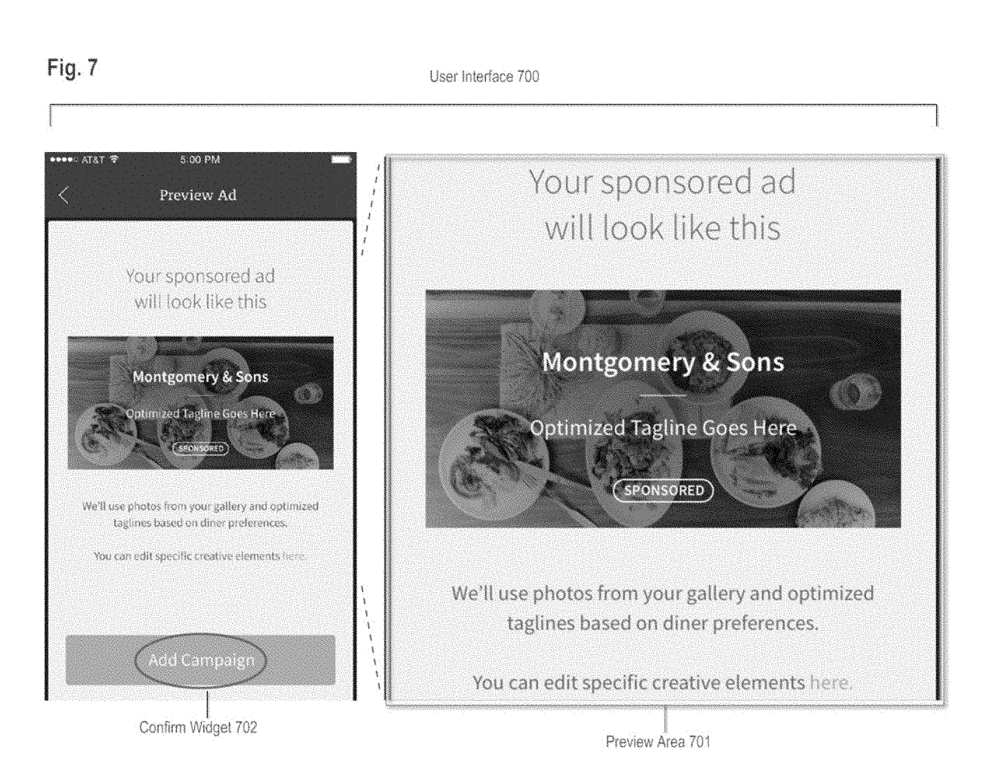

In an embodiment, the user interface 600 depicted in FIG. 6 is displayed in response to receiving a selection of a promotion via the promotion generation widget 501 of FIG. 5. Upon being provided with the user interface 600 a user may manipulate the price per cover widget 601 and/or the maximum expenditure widget 602 to set the amount the user is willing to spend per cover and the maximum expenditure per day respectively. Other embodiments may include more widgets for adjusting other settings of the promotion, such as selecting a promotion type, a target type of diner (e.g. regular, new diner, travelers, big spenders, etc.), a geographical location of diners to target, and so forth. Upon receiving the settings from the widgets (in this case the price per cover widget 601 and maximum expenditure widget 602), the driver sub-module 300 invokes the reach prediction sub-module 303 to calculate the estimated number of covers and revenue obtained from using a promotion with the specified settings. Thus, the estimated reach information 603 may be modified in real time as the user adjusts settings via the widgets. In an embodiment when the user is satisfied with the settings and predicted reach of the promotion, the preview widget 604 may be selected to generate the display depicted in FIG. 7.

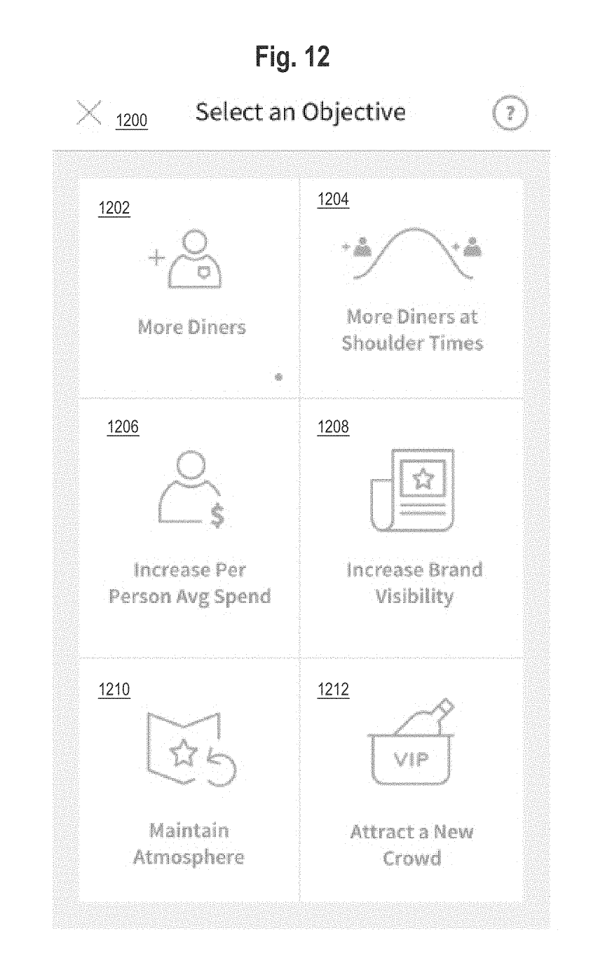

FIG. 12 illustrates another example of a promotion generation interface. In the example of FIG. 12, a screen display 1200 comprises a plurality of selectable icons, buttons or widgets 1202, 1204, 1206, 1208, 1210, 1212 each associated with invoking programming to form a campaign with a particular goal. For example, the widgets 1202, 1204, 1206, 1208, 1210, 1212 may be associated respectively with programming to create campaigns with the goals of: more diners; more diners at shoulder times; increase per person average spend; increase brand visibility; maintain atmosphere; attract a new crowd. “Shoulder times” may refer to non-peak times and may vary based upon market or geography; for example, in New York a peak dinner time may be 9:00 PM whereas in Phoenix it may be 7:00 PM and shoulder times would adjust outside the peak time accordingly. “Maintain atmosphere” may refer to attracting customers with similar profiles as in the past whereas “Attract a new crowd” may refer to attracting diners with different profiles.

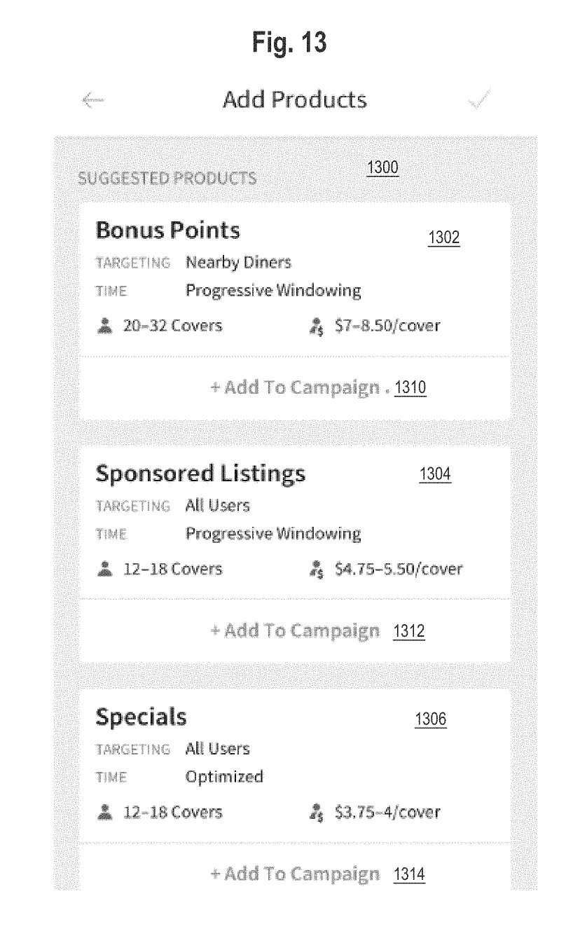

In an embodiment, selecting one of the widgets 1202, 1204, 1206, 1208, 1210, 1212 causes the system to generate and display a list of suggested products or promotions that can be selected and added to a campaign. FIG. 13 illustrates an example screen display of a mobile computing device showing all or part of three (3) different suggested promotions. In the example of FIG. 13, the screen display 1300 comprises a Bonus Points panel 1302, Sponsored Listings panel 1304 and Specials panel 1306. Each of the panels 1302, 1304, 1306 respectively comprises an Add to Campaign link 1310, 1312, 1314 which may be selected to cause adding a promotion of the corresponding type to a current promotional campaign. In an embodiment, each of the panels 1302, 1304, 1306 comprises a name, a targeting indication, a time indication, a cover prediction value, and a spend prediction value. For example, for panel 1302, the name is Bonus Points, the targeting indication is Nearby Diners, the time indication is Progressive Windowing, the cover prediction value is 20-32 added covers, and the spend prediction value is $7 to $8.50 more per cover. Targeting values typically are geographic and refer to all diners or nearby diners, but can refer to other demographic values of diners that are stored in the system. Time values may use a variety of approaches including selective offers in different windows of time, optimized offering based on time of day, or others. The calculation and display of predicted added covers and spend amounts are described in other sections herein for other interface examples. Although three (3) panels are shown in FIG. 13 to illustrate a clear example, other embodiments may include any number of panels.

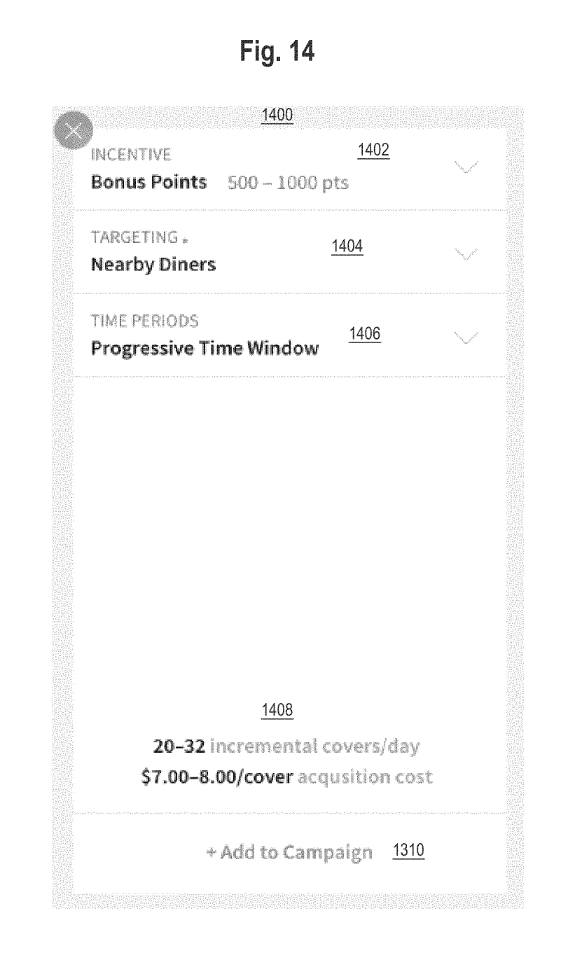

FIG. 14 illustrates an example screen display of a mobile computing device showing a detailed view of the Bonus Points promotion of FIG. 13. In FIG. 14, a screen display 1400 comprises an incentive panel 1402, a targeting panel 1404, a time period panel 1406, and a prediction data panel 1408. The Add to Campaign link 1310 of FIG. 13 also is displayed in screen display 1400. In an embodiment, each of the incentive panel 1402, targeting panel 1404, and time period panel 1406 is programmed as a pull-down menu which when tapped or otherwise selected transforms to a list of selectable options. For example, the incentive panel 1402 of FIG. 14 shows “500-1000 pts” has been selected or provided as a default value; selecting a carat icon in the panel causes the mobile computing device to display a pull-down menu of other ranges of points that can be selected and applied.

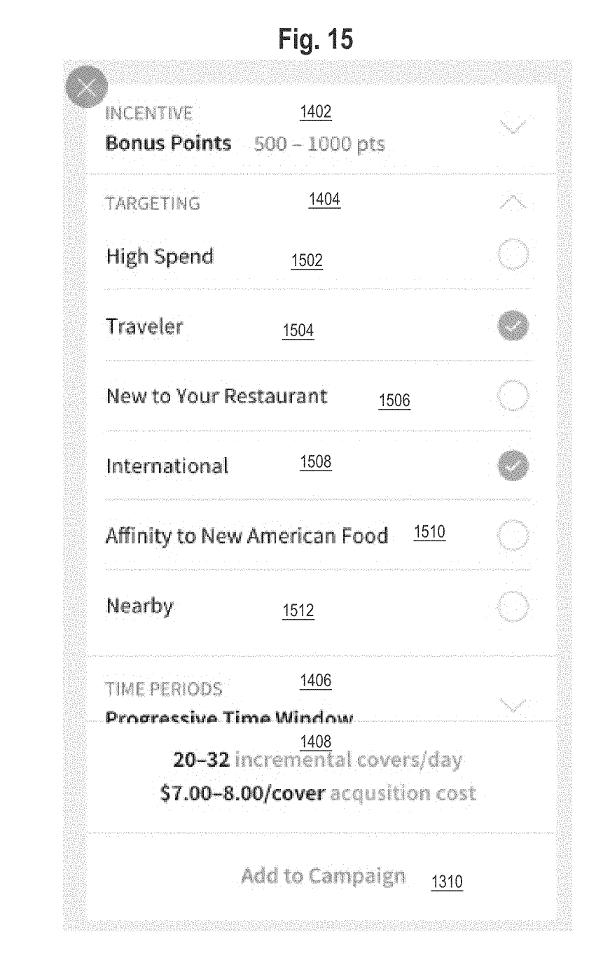

The other panels 1404, may be programmed to operate in the same manner. FIG. 15 illustrates the same example screen display of FIG. 14 except that the targeting panel has been expanded by tapping or other user input. In an embodiment, in FIG. 15, the targeting panel 1404 is expanded or opened to display a plurality of targeting options 1502, 1504, 1506, 1508, 1510, 1512, each having an associated button or checkbox that may be selected to activate the associated targeting option as part of the current promotion. In the example of FIG. 15, a Traveler option 1504 and an International option 1508 are selected to indicate that the restaurant is seeking a promotion that targets international travelers, based upon stored profile data available to the system. Other targeting options may seek to attract high spending diners, new diners, nearby diners and others. Each of the targeting options is associated with activating specific server-side programming or code that will generate database queries or other targeting instructions to cause later displaying the associated promotion to diner users of mobile computing devices whose profile data or past restaurant selections correspond to the selected targeting options.

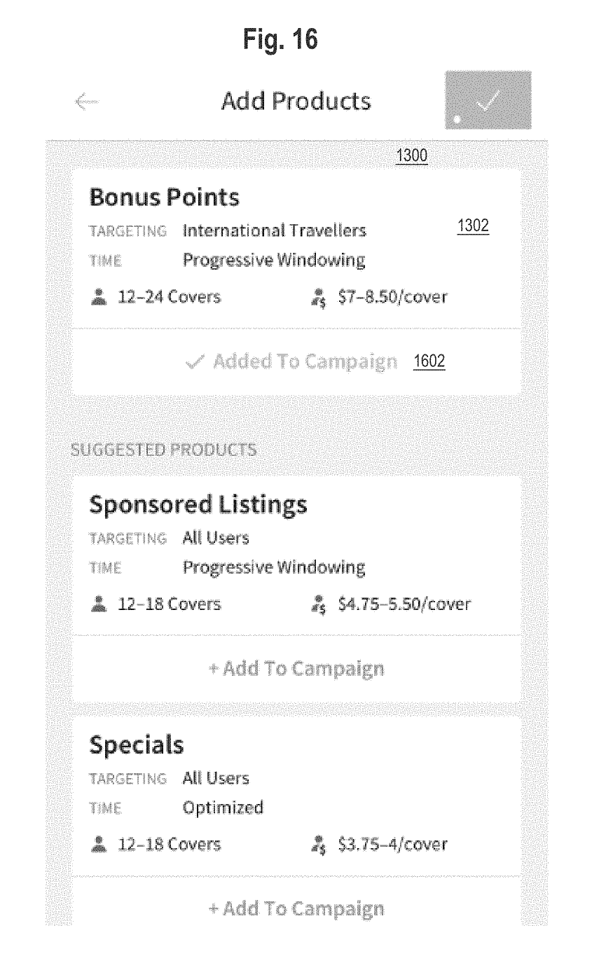

In an embodiment, selecting the Add to Campaign link 1310 of screen display 1400 instructs the program to add the current promotion with all currently selected options to a current campaign. In an embodiment, the link 1310 is programmed also to cause the mobile device to transition back to the screen display 1300 of FIG. 13 with an indication that the promotion was added. FIG. 16 illustrates the screen display of FIG. 13 after a promotion has been added to a campaign. In FIG. 16, screen display 1300 has the same format and content as in FIG. 13, but the Add to Campaign link 1310 is replaced by an “Added to Campaign” message 1602 to confirm that the promotion addressed in FIG. 14, FIG. 15 has been added.

### 5.3 Content Display Preview User Interface

FIG. 7 illustrates an example content display preview interface according to an embodiment. In FIG. 7 the user interface 700 includes a preview area 701 and a confirm widget 702.

In an embodiment, the preview area 701 depicts a preview of the content display that will be used to advertise the promotion. In some embodiments, as discussed above, the content display may be generated automatically by the content display generator sub-module 304. For example, the content display generator sub-module 304 may select a graphic from a library of graphics and imprint the graphic with text identifying the restaurant and/or details of the promotion. However, in other embodiments, the content display may be generated automatically, but with the user interface 700 providing one or more widgets that allow the content display to be customized or a link to another interface that allows customization of the content display.

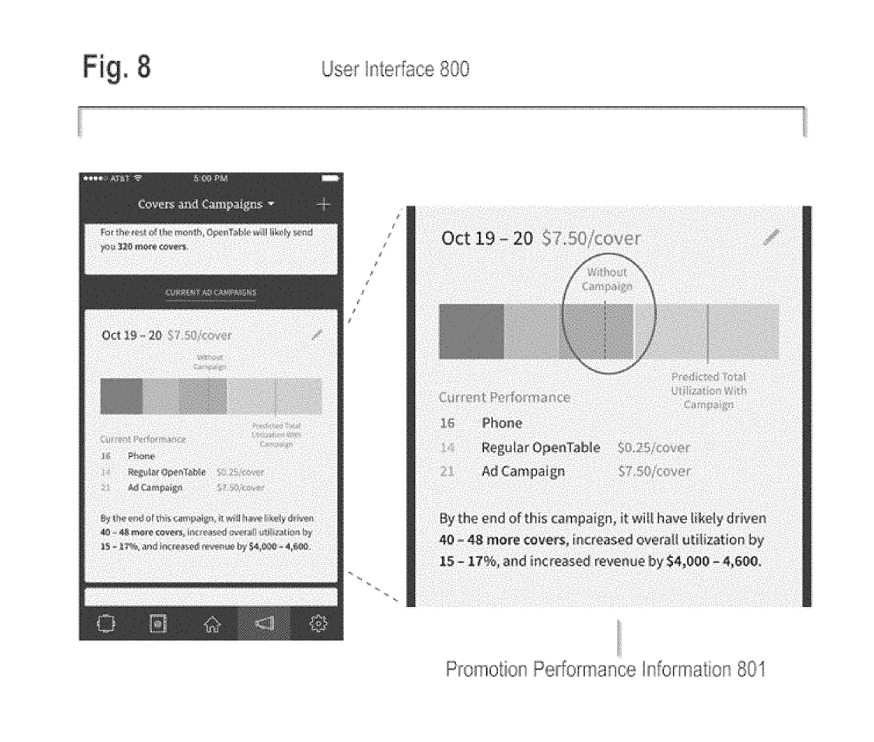

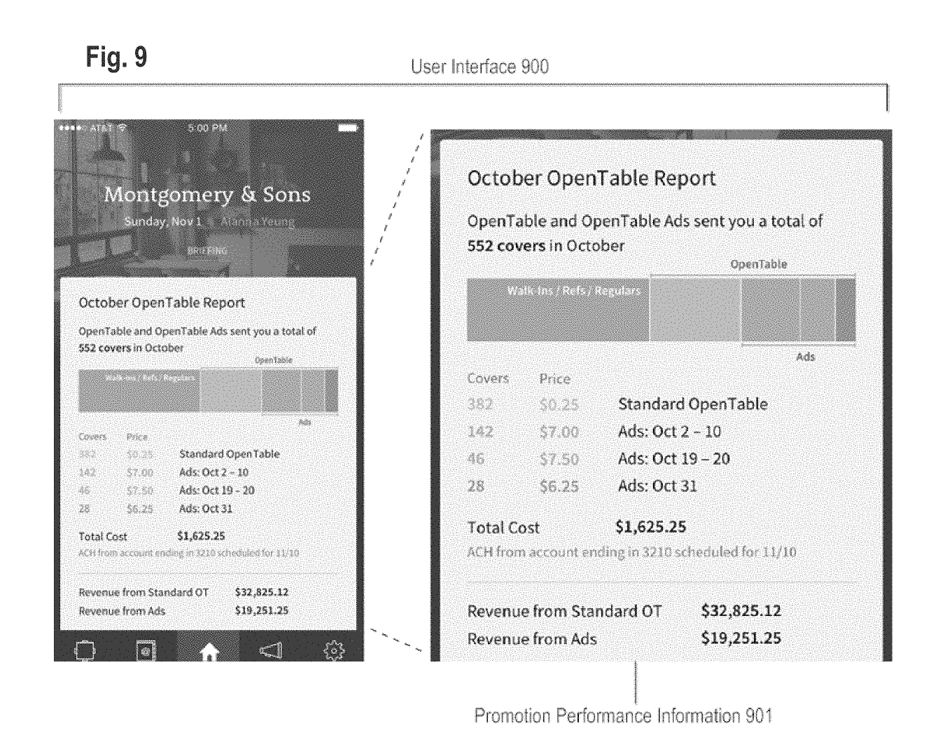

In an embodiment, the confirm widget 702 confirms the content display to use while publishing the promotion. In some embodiments, selecting the confirm widget 702 causes generation of the interface depicted in FIG. 8 or FIG. 9.

### 5.4 Promotion Results User Interface

FIG. 8 illustrates a promotion results interface according to an embodiment. In FIG. 8, the user interface 800 includes promotion performance information 801.

In an embodiment, user interface 800 is displayed after selecting the confirm widget 702. However, since the performance of the promotion may take time to measure, embodiments allow a user who logs into the self-serve advertising service to revisit user interface 800 to monitor the current or past performance of a promotion. For example, user interface 800 may represent a home user interface to which a user is first directed after login in or may be displayed as a result of clicking a link or widget displayed on the home user interface.

In some embodiments, the promotion performance information 801 includes a graphic depicting how many covers and/or how much revenue was obtained from a plurality of sources (e.g. from mobile devices on which the promotion was displayed, from web browsers, overall sources, and so forth). In some embodiments, the promotion performance information 801 includes a graphic that depicts the predicted number of covers without the promotion, the current number of covers so far after running the promotion, and the number of covers estimated to be obtained from the promotions. The aforementioned graphic may be a bar chart, line graph, or any other suitable graphic. In some embodiments, the promotion performance information 801 also contains a textual description of how many covers and/or how much revenue the promotion is likely to net for the restaurant by the end of the promotion.

In some embodiments the promotion performance information 801 is updated in real time. For example, every time a reservation is reserved through the reservation service provided by the reservation module 201 using the promotion the reservation module 201 may update the number of covers and/or estimated revenue stored in association with the promotion within reservation database 105, which is then relied upon by the driver sub-module 300 to display user interface 800. In addition, the reservation database 105 may also receive updates from a point of sale system associated with the restaurant that allows actual covers and/or revenue to be displayed by user interface 800.

### 5.5 Alternative Promotion Results Interface

FIG. 9 illustrates an alternative promotion results interface according to an embodiment. In FIG. 9, the user interface 900 includes promotion performance information 901.

In an embodiment, user interface 900 is displayed after selecting the confirm widget 702. However, since the performance of the promotion may take time to measure, embodiments allow a user who logs into the self-serve advertising service to revisit user interface 900 to monitor the current or past performance of a promotion. For example, user interface 900 may represent a home user interface to which a user is first directed after login in or may be displayed as a result of clicking a link or widget displayed on the home user interface.

In some embodiments, the promotion performance information 901 includes a graphic depicting how many covers were obtained through the promotion, through the reservation service provided by the reservation module 201, and/or other diners. For example, the promotion performance information 901 may depict a bar chart displaying the breakdown of customers by source. In addition, the promotion performance information 901 may display how effective various promotions were over periods of time, such as how many covers the promotion brought in, the dates over which the promotion ran, the cost of the promotion to the restaurant, the amount of revenue each promotion brought in, the total amount spent on promotions to date, breakdown of revenue by source, and so forth.

In some embodiments the promotion performance information 901 is updated in real time. For example, every time a reservation is reserved through the reservation service provided by the reservation module 201 using the promotion the reservation module 201 may update the number of covers and/or estimated revenue stored in association with the promotion within reservation database 105, which is then relied upon by the driver sub-module 300 to display user interface 900. In addition, the reservation database 105 may also receive updates from a point of sale system associated with the restaurant that allows actual covers and/or revenue to be displayed by user interface 900.

### 6.0 Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

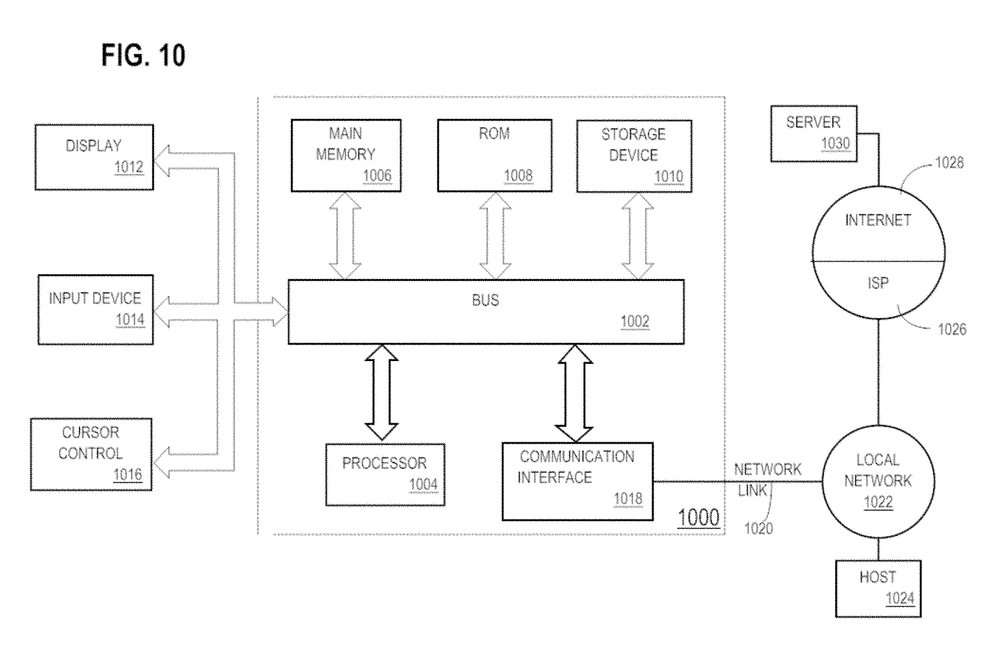

For example, FIG. 10 is a block diagram that illustrates a computer system 1000 upon which an embodiment of the invention may be implemented. Computer system 1000 includes a bus 1002 or other communication mechanism for communicating information, and a hardware processor 1004 coupled with bus 1002 for processing information. Hardware processor 1004 may be, for example, a general purpose microprocessor.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or solid-state drive is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1010. Volatile media includes dynamic memory, such as main memory 1006. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world wide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving, at a reservation server, from a restaurant client, data identifying a particular restaurant or a user associated with the particular restaurant;
predicting, by the reservation server, one or more future periods of time for which the particular restaurant is likely to receive less than an average amount of covers;
automatically generating, by the reservation server, one or more promotions that are likely to increase covers to the particular restaurant during the one or more future periods of time;
causing, by the reservation server, the restaurant client to display the one or more promotion;
receiving, by the reservation server, from the restaurant client, selection of a particular promotion from the one or more promotions;
in response to receiving the selection of the particular promotion, the reservation server automatically generating a content display for the particular promotion;
causing, by the reservation server, the content display to be displayed by the restaurant client.

2. The method of claim 1, wherein the one or more promotions are displayed by the restaurant client in a user interface that includes one or more widgets for selecting one or more options for the particular promotion and receiving the selection of the particular promotion involves receiving the one or more options for the particular promotion.

3. The method of claim 1, wherein the content display is displayed by the restaurant client in a user interface that includes one or more widgets that modify one or more features of the content display.

4. The method of claim 1, wherein the reservation server executes a reservation service which is utilized by one or more diner clients to establish dining reservations with a plurality of restaurants.

5. The method of claim 4, further comprising:
receiving, at the reservation server, from the restaurant client, a confirmation for the content display;
in response to receiving the confirmation for the content display, publishing the particular promotion using the content display.

6. The method of claim 5, wherein publishing the particular promotion causes the content display to be displayed when the one or more diner clients execute a search for restaurants that is satisfied by the particular restaurant.

7. The method of claim 6, wherein the content display is displayed above other restaurants displayed as a result of the search that are not running a promotion.

8. The method of claim 4, further comprising:
after publishing the particular promotion, causing, by the reservation server, a user interface to be displayed by the restaurant client that presents one or more factors related to effectiveness of the particular promotion.

9. The method of claim 8, wherein the user interface is updated in real-time.

10. The method of claim 5, wherein the one or more promotions are automatically generated at least in part based on statistics related to how effective previously run promotions were at increasing covers and further comprising:
in response to the particular promotion ending, adding one or more statistics related to effectiveness of the particular promotion to the statistics related to how effective the previously run promotions were at increasing covers.

11. The method of claim 10, further comprising:
after adding the one or more statistics related to the effectiveness of the particular promotion to the statistics related to how effective the previously run promotions were at increasing covers:
receiving, at the reservation server, from a second restaurant client, data identifying a second particular restaurant or a second user associated with the second particular restaurant;
predicting, by the reservation server, second one or more future periods of time for which the second particular restaurant is likely to receive less than a second average amount of covers;
automatically generating, by the reservation server, a second one or more promotions that are likely to increase covers to the second particular restaurant during the second one or more future periods of time based at least in part on the statistics related to how effective the previously run promotions were at increasing covers.

12. A server computer comprising:
one or more digital electronic processors;
one or more non-transitory data storage media coupled to the one or more processors and storing one or more sequences of instructions which when executed by the one or more processors cause performing the steps of:
receiving, from a restaurant client, data identifying a particular restaurant or a user associated with the particular restaurant;
predicting one or more future periods of time for which the particular restaurant is likely to receive less than an average amount of covers;
automatically generating one or more promotions that are likely to increase covers to the particular restaurant during the one or more future periods of time;
causing the restaurant client to display the one or more promotions;
receiving, from the restaurant client, selection of a particular promotion from the one or more promotions;
in response to receiving the selection of the particular promotion, automatically generating a content display for the particular promotion;
causing the content display to be displayed by the restaurant client.

13. The server computer of claim 12, further comprising one or more sequences of instructions which when executed by the one or more processors cause displaying the one or more promotions by the restaurant client in a user interface that includes one or more widgets for selecting one or more options for the particular promotion and receiving the selection of the particular promotion involves receiving the one or more options for the particular promotion.

14. The server computer of claim 12, further comprising one or more sequences of instructions which when executed by the one or more processors cause displaying the content display by the restaurant client in a user interface that includes one or more widgets that modify one or more features of the content display.

15. The server computer of claim 12, further comprising one or more sequences of instructions which when executed by the one or more processors cause executing a reservation service which is utilized by one or more diner clients to establish dining reservations with a plurality of restaurants.

16. The server computer of claim 15, further comprising one or more sequences of instructions which when executed by the one or more processors cause:
receiving, from the restaurant client, a confirmation for the content display;
in response to receiving the confirmation for the content display, publishing the particular promotion using the content display.

17. The server computer of claim 15, further comprising one or more sequences of instructions which when executed by the one or more processors cause, publishing the particular promotion by causing the content display to be displayed when the one or more diner clients execute a search for restaurants that is satisfied by the particular restaurant.

18. The server computer of claim 17, further comprising one or more sequences of instructions which when executed by the one or more processors cause displaying the content display above other restaurants displayed as a result of the search that are not running a promotion.

19. The server computer of claim 15, further comprising one or more sequences of instructions which when executed by the one or more processors cause:
after publishing the particular promotion, causing, by the reservation server, a user interface to be displayed by the restaurant client that presents one or more factors related to effectiveness of the particular promotion.

20. The server computer of claim 19, further comprising one or more sequences of instructions which when executed by the one or more processors cause updating the user interface in real-time.

21. The server computer of claim 16, further comprising one or more sequences of instructions which when executed by the one or more processors cause automatically generating the one or more promotions at least in part based on statistics related to how effective previously run promotions were at increasing covers and further comprising:
in response to the particular promotion ending, adding one or more statistics related to effectiveness of the particular promotion to the statistics related to how effective the previously run promotions were at increasing covers.

22. The server computer of claim 21, further comprising one or more sequences of instructions which when executed by the one or more processors cause:
receiving, from a second restaurant client, data identifying a second particular restaurant or a second user associated with the second particular restaurant;
predicting a second one or more future periods of time for which the second particular restaurant is likely to receive less than a second average amount of covers;
automatically generating a second one or more promotions that are likely to increase covers to the second particular restaurant during the second one or more future periods of time based at least in part on the statistics related to how effective the previously run promotions were at increasing covers.
